(19) United States
(12) Patent Application Publication
(10) Pub. No.: US 2024/0184571 A1
(43) Pub. Date: Jun. 6, 2024

(54) Accelerated Vector Reduction Operations

(71) Applicant: SiFive, Inc., San Mateo, CA (US)

(72) Inventors: Nicolas Rémi Brunie, San Mateo, CA (US); Kaihsiang Tsao, Hsinchu (TW); Yueh Chi Wu, Taichung City (TW)

(21) Appl. No.: 18/524,391

(22) Filed: Nov. 30, 2023

Related U.S. Application Data
(60) Provisional application No. 63/429,972, filed on Dec. 2, 2022.

(51) Int. Cl. G06F 9/30

(52) U.S. Cl. CPC G06F 9/3001; G06F 9/3012

(57) ABSTRACT

Systems and methods are disclosed for accelerated vector-reduction operations. Some systems may include a vector register file configured to store register values of an instruction set architecture in physical registers; and an execution circuitry configured to, responsive to a folding micro-op: read a vector from a physical register of the vector register file or from bypass circuitry; partition the elements of the vector into a first subset of elements with even indices and a second subset with elements with odd indices; and apply a reduction operation to combine elements from the second subset of elements with corresponding elements from the first subset of elements to obtain a set of reduced elements.

### TECHNICAL FIELD

This disclosure relates to accelerated vector-reduction operations.

### BACKGROUND

Vector reduction is an operation or sequence of operations that can reduce a vector, which comprises a set of elements, to a smaller set of elements or to a single element. Each element of a vector may be stored in one or more vector registers of a vector register file of an integrated circuit, for example, a system-on-Chip (SoC). Vector reductions may be ordered or unordered. In an ordered vector reduction, a result of the reduction depends on an order of operations on the elements. In an unordered vector reduction, a result of the reduction does not depend on an order of operations on the elements. One example where vector reductions may be useful is in matrix multiplication, such as an inner product of two matrices.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an exemplary system for facilitating generation and manufacture of integrated circuits.

FIG. 2 is a block diagram of an exemplary system for facilitating generation of a circuit representation.

FIG. 3A is a block diagram of an example of an integrated circuit for accelerated vector-reduction operations.

FIG. 3B is a block diagram of an example of an integrated circuit for accelerated vector-reduction operations.

FIG. 4 is a representation of a circuitry configured to perform accelerated vector-reduction operations.

FIG. 5 is a representation of a circuitry configured to perform accelerated vector-reduction operations.

FIG. 6 is a flowchart of an example of a technique for accelerated vector-reduction operations.

### DETAILED DESCRIPTION

Vector reduction can reduce a large vector, which comprises a set of elements, to a smaller set of elements or to a single element. Each element of a vector may be stored in one or more vector registers of a vector register file of an integrated circuit, and conversely, each vector register may store one or more elements (depending on a size of each element relative to a size of each vector register). In some implementations of version five of the Reduced Instruction Set Computer (RISC-V) architecture, a large vector may comprise 1, 2, 4, or 8 vector registers that may be called a vector-register group, and each vector register may have a size of, for example, 128 bits. As used herein, the term “element” refers to a contiguous group of data bits (e.g., a nibble, a byte, or a word).

To improve one or more of execution time, circuit area, circuit complexity, power consumption, and so on, a vector-reduction operation, or macro-op, can be divided into different phases that can be executed sequentially. One or more phases may utilize much of the same circuitry, for example, to reduce circuit area. Alternatively, one or more phases may utilize substantially separate circuitry that is optimized for a particular phase, for example, to reduce execution time. A vector sequencer circuitry determines an appropriate sequence of micro-ops to control the flow and processing of elements within each phase and between phases. Each phase may require one or more micro-ops. Within each phase, one or more elements is input to an execution unit for processing. As used herein, the term “circuitry” refers to an arrangement of electronic components (e.g., transistors, resistors, capacitors, and/or inductors) that is structured to implement one or more functions. For example, a circuitry may include one or more transistors interconnected to form logic gates that collectively implement a logical function.

Vector reductions may be ordered or unordered. In an ordered vector reduction, a result of the reduction depends on an order of operations on the elements. In an unordered vector reduction, several different orders of operations on the elements may yield valid results; thus, the validity of a result of an unordered vector reduction does not depend on the order of operations on the elements. Examples of unordered vector-reduction operations include integer addition (with wrap-around on overflow), minimum, maximum, logical AND, logic OR, and logical XOR. For example, a part of an integer addition vector reduction of a large vector comprising a set of elements may be implemented via pairwise additions of the elements or pairwise additions of respective elements of subsets of the elements (both may be referred to herein as elementwise). As another example, a part of a logical AND vector reduction of the large vector may be implemented via pairwise ANDs of the elements or pairwise ANDs of subsets of the elements (where a bitwise AND is performed between each pair of elements or between each pair of subsets of elements). Pairwise vector-reduction operations may be performed on the results of earlier pairwise vector-reduction operations until a single element remains. Floating-point addition vector reduction may be implements in either an ordered or unordered manner.

Various forms of parallelism may be used to reduce the time required to perform a vector reduction, especially an unordered vector reduction. Data-level parallelism can be considered parallelism by dividing an operation across multiple instances of circuitry, for example, across multiple execution units (e.g., multiple arithmetic logic units (ALU)). Data-level parallelism can leverage multiple instances of circuitry, e.g., multiple execution units, to process elements in parallel. Pipeline parallelism can be considered parallelism by dividing an operation into a sequence of processing stages and staggering the processing of segments of the operation across the stages, for example across multiple pipeline stages of a pipelined execution unit (e.g., a pipelined ALU). Pipeline parallelism can leverage pipelined circuitry, e.g., a pipelined execution unit, to stagger and overlap the processing of elements via a sequence of pipeline stages.

The implementations herein disclose vector-reduction execution circuitry that partitions a vector-reduction macro-op into multiple phases, where the phases may utilize much of the same circuitry or they may utilize substantially separate circuitry, and the phases may utilize data-level parallelism and/or pipeline parallelism. The vector-reduction execution circuitry may include a vector sequencer circuitry that determines an appropriate sequence of micro-ops to control the flow and processing of elements within each phase and between phases. Elements, or subsets of elements, may be processed via one or more execution units (e.g., arithmetic circuitry) that execute micro-ops in a determined sequence. A given execution unit may take as input a single vector register, two vector registers, or more than two vector registers.

In one embodiment, a vector-reduction macro-op may be divided into three phases, comprising: a first vertical reduction phase; a second folding phase; and a third horizontal reduction phase, each of which are described in more detail further below. The vector sequencer determines a first sequence of first micro-ops for the first vertical phase; a second sequence of second micro-ops for the second folding phase; and a third sequence of third micro-ops for the third horizontal phase. In some implementations, a sequence of micro-ops may consist of only a single micro-op.

Some implementations described herein may provide advantages over conventional systems for implementing reduction operations, such as improved execution time, circuit area, circuit complexity, and power consumption. To describe some implementations in greater detail, reference is first made to examples of hardware and software structures used to implement a system including components that may perform accelerated vector-reduction operations.

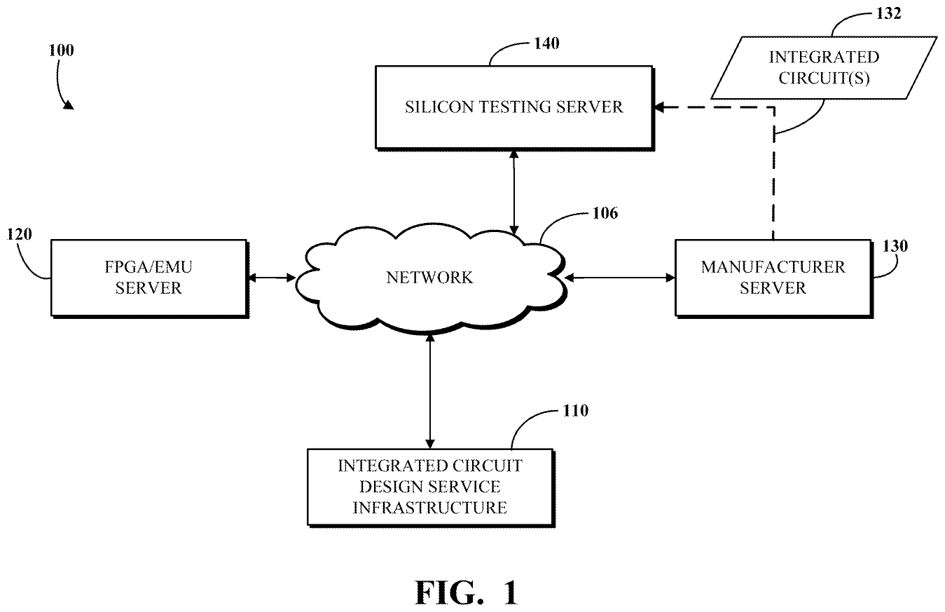

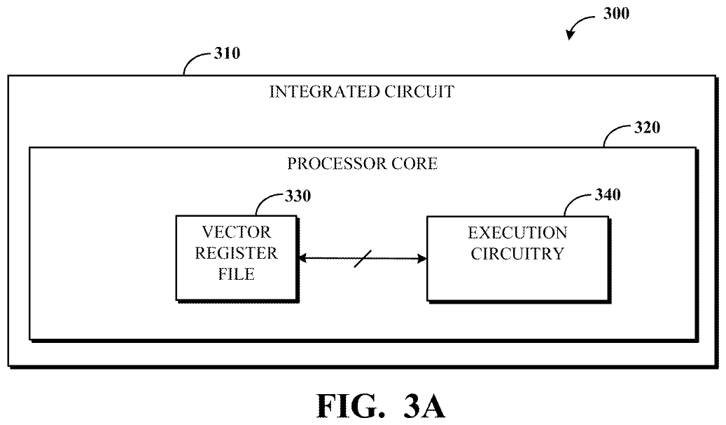

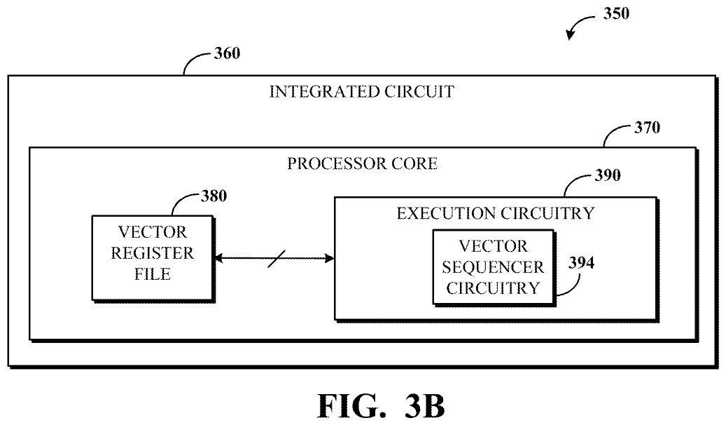

FIG. 1 is a block diagram of an example of a system 100 for generation and manufacture of integrated circuits. The system 100 includes a network 106, an integrated circuit design service infrastructure 110 (e.g., integrated circuit generator), a field programmable gate array (FPGA)/emulator server 120, and a manufacturer server 130. For example, a user may utilize a web client or a scripting application program interface (API) client to command the integrated circuit design service infrastructure 110 to automatically generate an integrated circuit design based on a set of design parameter values selected by the user for one or more template integrated circuit designs. In some implementations, the integrated circuit design service infrastructure 110 may be configured to generate an integrated circuit design like the integrated circuit design shown and described in FIGS. 3-6.

The integrated circuit design service infrastructure 110 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high-level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 110 may invoke (e.g., via network communications over the network 106) testing of the resulting design that is performed by the FPGA/emulation server 120 that is running one or more FPGAs or other types of hardware or software emulators. For example, the integrated circuit design service infrastructure 110 may invoke a test using a field programmable gate array, programmed based on a field programmable gate array emulation data structure, to obtain an emulation result. The field programmable gate array may be operating on the FPGA/emulation server 120, which may be a cloud server. Test results may be returned by the FPGA/emulation server 120 to the integrated circuit design service infrastructure 110 and relayed in a useful format to the user (e.g., via a web client or a scripting API client).

The integrated circuit design service infrastructure 110 may also facilitate the manufacture of integrated circuits using the integrated circuit design in a manufacturing facility associated with the manufacturer server 130. In some implementations, a physical design specification (e.g., a graphic data system (GDS) file, such as a GDSII file) based on a physical design data structure for the integrated circuit is transmitted to the manufacturer server 130 to invoke manufacturing of the integrated circuit (e.g., using manufacturing equipment of the associated manufacturer). For example, the manufacturer server 130 may host a foundry tape-out website that is configured to receive physical design specifications (e.g., such as a GDSII file or an open artwork system interchange standard (OASIS) file) to schedule or otherwise facilitate fabrication of integrated circuits. In some implementations, the integrated circuit design service infrastructure 110 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 110 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 130 may fabricate and/or test integrated circuits based on the integrated circuit design. For example, the associated manufacturer (e.g., a foundry) may perform optical proximity correction (OPC) and similar post-tape-out/pre-production processing, fabricate the integrated circuit(s) 132, update the integrated circuit design service infrastructure 110 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 110 on the status of the packaging and delivery process periodically or asynchronously. In some implementations, status updates may be relayed to the user when the user checks in using the web interface, and/or the controller might email the user that updates are available.

In some implementations, the resulting integrated circuit(s) 132 (e.g., physical chips) are delivered (e.g., via mail) to a silicon testing service provider associated with a silicon testing server 140. In some implementations, the resulting integrated circuit(s) 132 (e.g., physical chips) are installed in a system controlled by the silicon testing server 140 (e.g., a cloud server), making them quickly accessible to be run and tested remotely using network communications to control the operation of the integrated circuit(s) 132. For example, a login to the silicon testing server 140 controlling a manufactured integrated circuit(s) 132 may be sent to the integrated circuit design service infrastructure 110 and relayed to a user (e.g., via a web client). For example, the integrated circuit design service infrastructure 110 may be used to control testing of one or more integrated circuit(s) 132.

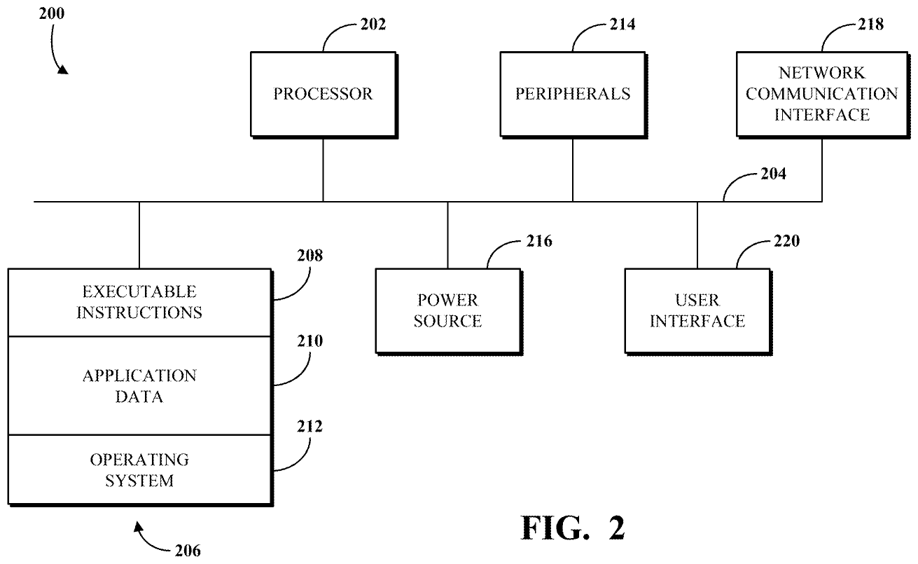

FIG. 2 is a block diagram of an example of a system 200 for facilitating generation of integrated circuits, for facilitating generation of a circuit representation for an integrated circuit, and/or for programming or manufacturing an integrated circuit. The system 200 is an example of an internal configuration of a computing device. The system 200 may be used to implement the integrated circuit design service infrastructure 110, and/or to generate a file that generates a circuit representation of an integrated circuit design like the integrated circuit design shown and described in FIGS. 3-6. The system 200 can include components or units, such as a processor 202, a bus 204, a memory 206, peripherals 214, a power source 216, a network communication interface 218, a user interface 220, other suitable components, or a combination thereof.

The processor 202 can be a central processing unit (CPU), such as a microprocessor, and can include single or multiple processors having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired or networked, including wirelessly networked. In some implementations, the operations of the processor 202 can be distributed across multiple physical devices or units that can be coupled directly or across a local area or other suitable type of network. In some implementations, the processor 202 can include a cache, or cache memory, for local storage of operating data or instructions.

The memory 206 can include volatile memory, non-volatile memory, or a combination thereof. For example, the memory 206 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 206 can include another type of device, or multiple devices, now existing or hereafter developed, capable of storing data or instructions for processing by the processor 202. The processor 202 can access or manipulate data in the memory 206 via the bus 204. Although shown as a single block in FIG. 2, the memory 206 can be implemented as multiple units. For example, a system 200 can include volatile memory, such as random-access memory (RAM), and persistent memory, such as a hard drive or other storage.

The memory 206 can include executable instructions 208, data, such as application data 210, an operating system 212, or a combination thereof, for immediate access by the processor 202. The executable instructions 208 can include, for example, one or more application programs, which can be loaded or copied, in whole or in part, from non-volatile memory to volatile memory to be executed by the processor 202. The executable instructions 208 can be organized into programmable modules or algorithms, functional programs, codes, code segments, or combinations thereof to perform various functions described herein. For example, the executable instructions 208 can include instructions executable by the processor 202 to cause the system 200 to automatically, in response to a command, generate an integrated circuit design and associated test results based on a design parameters data structure. The application data 210 can include, for example, user files, database catalogs or dictionaries, configuration information or functional programs, such as a web browser, a web server, a database server, or a combination thereof. The operating system 212 can be, for example, Microsoft Windows®, macOS®, or Linux®; an operating system for a small device, such as a smartphone or tablet device; or an operating system for a large device, such as a mainframe computer. The memory 206 can comprise one or more devices and can utilize one or more types of storage, such as solid-state or magnetic storage.

The peripherals 214 can be coupled to the processor 202 via the bus 204. The peripherals 214 can be sensors or detectors, or devices containing any number of sensors or detectors, which can monitor the system 200 itself or the environment around the system 200. For example, a system 200 can contain a temperature sensor for measuring temperatures of components of the system 200, such as the processor 202. Other sensors or detectors can be used with the system 200, as can be contemplated. In some implementations, the power source 216 can be a battery, and the system 200 can operate independently of an external power distribution system. Any of the components of the system 200, such as the peripherals 214 or the power source 216, can communicate with the processor 202 via the bus 204.

The network communication interface 218 can also be coupled to the processor 202 via the bus 204. In some implementations, the network communication interface 218 can comprise one or more transceivers. The network communication interface 218 can, for example, provide a connection or link to a network, such as the network 106 shown in FIG. 1, via a network interface, which can be a wired network interface, such as Ethernet, or a wireless network interface. For example, the system 200 can communicate with other devices via the network communication interface 218 and the network interface using one or more network protocols, such as Ethernet, transmission control protocol (TCP), Internet protocol (IP), power line communication (PLC), Wi-Fi, infrared, general packet radio service (GPRS), global system for mobile communications (GSM), code division multiple access (CDMA), or other suitable protocols.

A user interface 220 can include a display; a positional input device, such as a mouse, touchpad, touchscreen, or the like; a keyboard; or other suitable human or machine interface devices. The user interface 220 can be coupled to the processor 202 via the bus 204. Other interface devices that permit a user to program or otherwise use the system 200 can be provided in addition to or as an alternative to a display. In some implementations, the user interface 220 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 214. The operations of the processor 202 can be distributed across multiple clients or servers, which can be coupled directly or across a local area or other suitable type of network. The memory 206 can be distributed across multiple clients or servers, such as network-based memory or memory in multiple clients or servers performing the operations of clients or servers. Although depicted here as a single bus, the bus 204 can be composed of multiple buses, which can be connected to one another through various bridges, controllers, or adapters.

A non-transitory computer-readable medium may store a circuit representation that, when processed by a computer, is used to program or manufacture an integrated circuit. For example, the circuit representation may describe the integrated circuit specified using a computer-readable syntax. The computer-readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer-readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer-readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

FIG. 3A is a block diagram of an example system 300 comprising an integrated circuit 310 for accelerated vector-reduction operations. The system 300 may be a system-on-chip (SoC) comprising one or more integrated circuits 310. The system 300 may comprise one or more of the components of the system 200 of FIG. 2. The integrated circuit 310 comprises a processor core 320, which may, for example, be the processor 202 of FIG. 2. The processor core 320 comprises a vector register file 330 communicatively coupled to an execution circuitry 340. The vector register file 330 may include vector registers capable of storing one or more elements of a vector, where the vector may be stored in one or more vector registers as a vector-register group. The execution circuitry 340 may include one or more execution units each capable of receiving one or more operands, e.g., elements, from one or more vector registers of the vector register file 330.

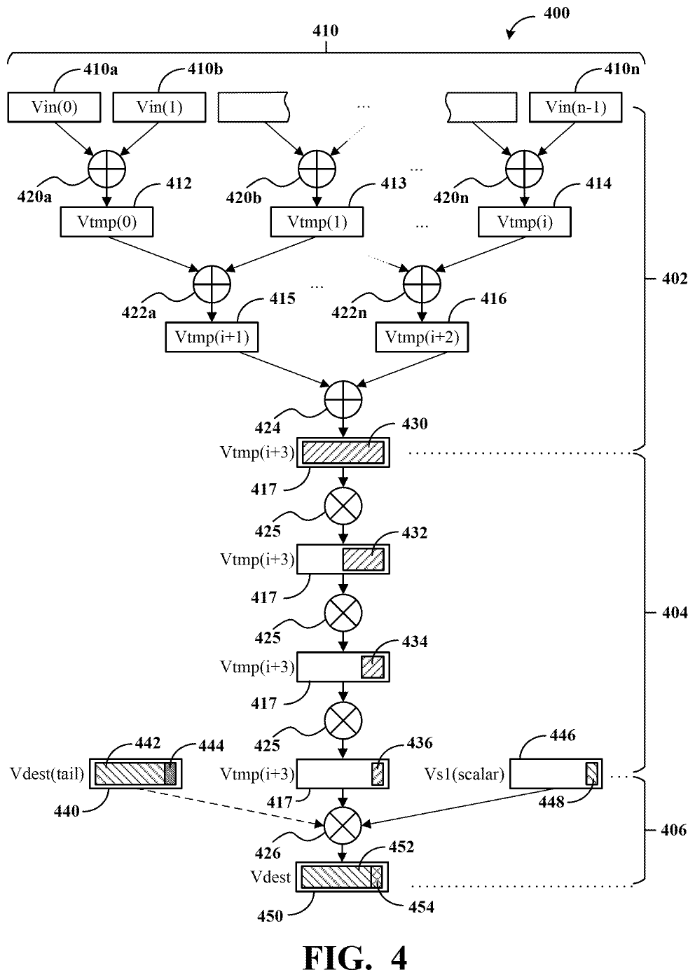

FIG. 3B is a block diagram of an example system 350 comprising an integrated circuit 360 for accelerated vector-reduction operations. The system 350 may be an SoC comprising one or more integrated circuits 360. The system 350 may comprise one or more of the components of the system 200 of FIG. 2. The integrated circuit 360 comprises a processor core 370, which may, for example, be the processor 202 of FIG. 2. The processor core 370 comprises a vector register file 380 communicatively coupled to an execution circuitry 390. The vector register file 380 may include vector registers capable of storing one or more elements of a vector, where the vector may be stored in one or more vector registers as a vector-register group. The execution circuitry 390 may include one or more execution units each capable of receiving one or more operands, e.g., elements, from one or more vector registers of the vector register file 380. The execution circuitry 390 may further include a vector sequencer circuitry 394 configured to determine an appropriate sequence of micro-ops to control the flow and processing of elements within each phase and between phases of a vector-reduction operation. For example, the vector sequencer circuitry 394 may be part of a dispatch stage in a vector pipeline of the processor core 370 and may be configured to crack a macro-op encoding of a vector reduction instruction into a sequence multiple micro-ops that perform the different phases and iterations of the vector reduction operation (e.g., the phases and iterations illustrated in FIG. 4) For example, in a vertical phase, a micro-op from the vector sequencer circuitry 394 may cause a pair of registers from a register group storing the source vector to be reduced to be read from the vector register file 380, or from bypass circuitry, to an execution unit of the execution circuitry 390 that is configured to apply the pairwise reduction operation to corresponding elements stored in the pair of vector registers to determine a reduced set of elements that can be written to a single vector register and/or passed to the iteration or phase of the vector reduction operation. The integrated circuit 360, processor core 370, vector register file 380, and execution circuitry 390 may be the integrated circuit 310, processor core 320, vector register file 330, and execution circuitry 340 of FIG. 3A.

FIG. 4 is a representation of a circuitry 400 configured to perform accelerated vector-reduction operations. The circuitry 400 may be implemented by the processor core 320 of FIG. 3. An example of a large vector input 410 is shown at the top of FIG. 4, where elements of the large vector input 410 are stored in individual vector registers 410a, 410b, through 410n, labeled “Vin(0),” “Vin(1),” and “Vin(n-1),” respectively. As a specific example, the large vector input 410 may consist of eight groups of elements each stored in an individual vector register 410a, 410b, through 410n, which may be labeled from right-to-left as Vin(0) (an even index), Vin(1) (an odd index), Vin(2) (an even index), through Vin(7) (an odd index). Alternatively, the order of the vector registers 410a, 410b, through 410n could have been reversed, such that Vin(0) would be the rightmost vector register and Vin(7) would be the leftmost vector register. An example of a scalar output is shown at the bottom of FIG. 4 stored in a destination vector register 450 labeled as “Vdest.”

The circuitry 400 is partitioned into three phases. Phase 402 may be referred to as a “vertical reduction” phase; phase 404 may be referred to as a “folding” phase (or a “folding reduction” phase); and phase 406 may be referred to as a “horizontal reduction” phase. Although each phase is depicted in FIG. 4 to include instances of certain components, these components may be shared within and/or between certain phases, such that these components are represented in duplicate in FIG. 4. As an example of sharing components within a phase, the execution units 420a, 420b, through 420n (or a subset thereof) in the phase 402 may be distinct execution units, e.g., multiple instances of a same or similar execution-unit circuitry, to leverage data-level parallelism. Alternatively, the execution units 420a, 420b, through 420n (or a subset thereof) may be a same execution unit, e.g., a pipelined execution unit, to leverage pipeline parallelism. As an example of sharing components between phases, the execution unit 424 in the phase 402 may be distinct from the execution unit 425 in the phase 404. Alternatively, the execution unit 424 in the phase 402 may be the execution unit 425 in the phase 404. Further, components, e.g., execution units, in each phase may be optimized according to characteristics or requirements of each phase, as described further below.

The example vertical reduction phase 402 comprises several levels of pairwise (i.e., elementwise) reduction operations. In general, there may be m levels of pairwise reduction operations for a vector input that consists of 2^{m} vector registers, i.e., a binary reduction tree. The example circuitry 400 of FIG. 4 depicts a vector input having eight vector registers, Vin(0) through Vin(7) (where Vin(7) is labeled as Vin(n-1) in FIG. 4). Thus, the example circuitry of FIG. 4 depicts three levels (where 2³=8).

The first level of pairwise reduction operations in the phase 402 comprises execution units 420a, 420b, through 420n, which receive as inputs the elements stored in each of the vector registers 410a, 410b, through 410n. For example, the execution unit 420a receives as inputs the elements stored in the vector register 410a and the elements stored in the vector register 410b, labeled as “Vin(0)” and “Vin(1),” respectively. The outputs, or results, of the execution units 420a, 420b, through 420n are stored in temporary vector registers 412, 413, through 414, labeled as “Vtmp(0),” “Vtmp(1),” and “Vtmp(i),” respectively. The execution units 420a, 420b, through 420n (or a subset thereof) may be a same execution unit or separate execution units.

The second level of pairwise reduction operations in the phase 402 comprises execution units 422a through 422n, which receive as inputs the elements stored in each of the vector registers 412, 413, through 414. For example, the execution unit 422a receives as inputs the elements stored in the vector register 412 and the elements stored in the vector register 413. The outputs, or results, of the execution units 422a through 422n are stored in temporary registers 415 through 416, labeled as “Vtmp(i+1)” and “Vtmp(i+2),” respectively. The execution units 422a through 422n (or a subset thereof) may be a same execution unit or separate execution units. Additionally or alternatively, the execution units 422a through 422n (or a subset thereof) of the phase 402 may be a same or a different execution unit as the execution units 420a, 420b, through 420n (or a subset thereof) of the phase 402, such that the first level and the second level of the phase 402 may be equivalent to a first iteration and a second iteration.

The third level of pairwise reduction operations in the phase 402 comprises an execution unit 424, which receives as inputs the elements stored in the vector registers 415 and 416. The output, or result, of the execution unit 424 is stored in a temporary vector register 417, labeled as “Vtmp(i+3).” The execution unit 424 of the phase 402 may be a same or a different execution unit as one of the execution units 420a, 420b, through 420n of phase 402, such that the first level and the third level may be equivalent to a first iteration and a third iteration. Additionally or alternatively, the execution unit 424 of phase 402 may be a same or a different execution unit as one of the execution units 422a through 422n of phase 402, such that the second level and the third level may be equivalent to a second iteration and a third iteration.

The example folding reduction phase 404 of FIG. 4 comprises several recursive iterations of reduction operations on the elements stored in the vector register 417. For example, in a first iteration, the execution unit 425 performs a vector-reduction operation on the elements 430 stored in the vector register 417 and writes the result back to the vector register 417 as a first reduced group of elements 432. In a second iteration, the execution unit 425 performs the vector-reduction operation on the first reduced group of elements 432 stored in the vector register 417 and writes the result back to the vector register 417 as a second reduced group of elements 434. In a third iteration, the execution unit 425 performs the vector-reduction operation on the second reduced group of elements 434 stored in the vector register 417 and writes the result back to the vector register 417 as a third reduced group of elements 436. In some implementations, the third reduced group of elements 436 is a single element. In some implementations, the number of iterations in the folding reduction phase 404 is equal to the number of levels in the vertical reduction phase 402. In some implementations, the elements that are reduced (via reduction operations) in the first iteration may be obtained from bypass circuitry (not shown in FIG. 4), such that the elements need not be originally stored in the vector register 417. In some implementations, the result of each vector-reduction operation need not be written back to the vector register 417 during each iteration; instead, bypass circuitry (not shown in FIG. 4) can transfer a reduced group of elements at the output of the execution unit 425 to the input of the execution unit 425 for processing during a next iteration.

The example horizontal reduction phase 406 of FIG. 4 comprises one level, or iteration, of a reduction operation on the third reduced group of elements 436 stored in the vector register 417 and a scalar 448 stored in a vector register 446 (labeled as “Vs1(scalar)”). The vector-reduction operation is performed by the execution unit 426 and the result 454 is written to a vector register 450 (labeled as “Vdest”). The execution unit 426 of the phase 406 may be a same or a different execution unit as one of the execution units 420a, 420b, through 420n, 422a through 422n, and 424 of phase 402. Similarly, the execution unit 426 of phase 406 may be a same or a different execution unit as the execution unit 425 of phase 404. In some implementations, optional tail data 442 from a vector register 440 may be copied, transferred, or otherwise preserved as tail data 452 stored in the destination vector register 450. For example, the vector register 440 may be the destination vector register 450, in which case the tail data 442 is retained in the destination vector register as tail data 452, and other data 444 stored in the vector register 440 is not retained.

In some implementations, the folding reduction phase 404 and the horizontal reduction phase 406 may be combined into a single phase that performs all reduction operations of both phases, including the optional copying, transferring, or otherwise preserving of the tail data 442. Such a combined phase may perform all reductions operations of the folding reduction phase 404 without writing intermediate results to the vector register 417.

The example three-phase vector-reduction circuitry depicted in FIG. 4 may operate on either integer or floating-point elements and with integer or floating-point vector-reduction operations. For example, addition, minimum, and maximum may be either integer or floating-point vector-reduction operations, and logical AND, logical OR, and logical XOR are integer vector-reduction operations. For floating-point vector-reduction operations, the execution units may be floating-point execution units, and for integer vector-reduction operations, the execution units may be integer execution units.

The architecture and/or implementation of the execution units within each phase may be optimized according to characteristics or requirements of each phase, for example, to minimize total execution time of each phase. In particular, a high-throughput execution-unit architecture and/or implementation (e.g., a single instruction, multiple data (SIMD) execution unit) can be used for the execution units 420a, 420b, through 420n, 422a through 422n, and 424 of the phase 402, where each execution unit is optimized to quickly execute many vector-reduction operations in parallel. Such high-throughput execution units may be well-suited for the phase 402 because there may be many parallel pairwise (e.g., elementwise) vector-reduction operations. Conversely, a low-latency execution-unit architecture and/or implementation can be used for the execution unit 425 of the phase 404, where the execution unit (or units) is optimized to execute successive individual vector-reduction operations quickly. Such a low-latency execution unit (or units) may be well-suited for the phase 404 because there may be many recursive (e.g., serial) vector-reduction operations. In some integer implementations of the accelerated vector-reduction operations disclosed herein, a same execution-unit architecture and/or implementation is used for all execution units of all phases, e.g., either high-throughput or low-latency execution units. In some floating-point implementations of the accelerated vector-reduction operations disclosed herein, a high-throughput execution-unit architecture and/or implementation is used for all execution units of the vertical reduction phase 402, and a low-latency execution-unit architecture and/or implementation is used for all execution units of the folding phase 404 and the horizontal phase 406.

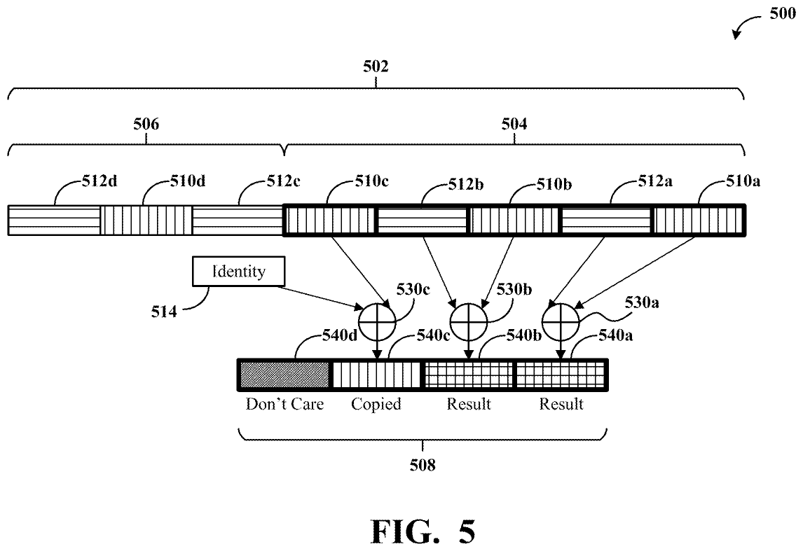

FIG. 5 is a representation of a circuitry 500 configured to perform accelerated vector-reduction operations. In particular, the circuitry 500 may implement an iteration of the folding phase 404 of FIG. 4, where each shaded rectangle corresponds to a portion of one vector register. For brevity, FIG. 5 is described herein only with respect to one iteration of the folding phase 404. Further, FIG. 5 depicts a specific example of the iteration of the folding phase 404, where the vector register 502 (which may be the temporary vector register 417 of FIG. 4) comprises eight segments, where each segment may correspond to a single element. In other example, the vector register 502 may comprise more or fewer segments.

During the folding phase 404, each of the eight elements of the vector register 502 is designated as either an “even” element 510a, 510b, 510c, and 510d, or an “odd” element 512a, 512b, 512c, and 512d according to its position in the vector register 502, where the even and odd elements alternate within the vector register 502. In other words, the vector register 502 is partitioned into a first subset of elements with even indices and a second subset of elements with odd indices. The execution unit 530a performs a vector-reduction operation on the first even element 510a and the first odd element 512a (counting from a least-significant bit (LSb) of the vector register 502), yielding a result 540a that is written to a vector register, such as the vector register 502 in place of the element 510a. Similarly, the execution unit 530b performs a vector-reduction operation on the second even element 510b and the second odd element 512b, yielding a result 540b that is written to a vector register, such as the vector register 502 in place of the element 512a.

In the example of FIG. 5, only five elements 504 of the eight possible elements of the vector register 502 contain valid data (i.e., data to be used in the vector-reduction operation), and three elements 506 contain invalid data (i.e., data not to be used in the vector-reduction operation). Thus, the third even element 510c does not have a corresponding valid third odd element 512c on which execution unit 530c can perform a vector-reduction operation. In this case, the execution unit 530c is configured by one or more of a sequence of micro-ops determined by a vector sequencer, for example the vector sequencer 394 of FIG. 3B, to perform the vector-reduction operation on the even element 510c and an identity value 514 specific to the vector-reduction operation, yielding a result 540c that is identical to element 510c. This result 540c is written (e.g., carried forward) to a vector register, such as the vector register 502 in place of the element 510b. The identity value 514 for the addition operation is zero; the identity value 514 for the minimum operation is the maximum value that can be represented by the system or a quiet not-a-number (NaN) for some versions of minimum over floating-point numbers; the identity value 514 for the maximum operation over unsigned integers is zero; the identity value 514 for the maximum operation over floating-point numbers is either minus infinity or a quiet NaN; the identity value 514 for the logical AND operation is a bit-vector of all logic-1 bits; the identity value 514 of the logical OR operation is a bit-vector of all logic-0 bits; and the identity value 514 of the logical XOR operation is a bit-vector of all logic-0 bits.

Because the remaining element in the vector register 502, namely even element 510d and odd element 512d, contain invalid data in the example of FIG. 5, they are not operated on by an execution unit, and don't-care data 540d (or nothing) is written to a vector register, such as the vector register 502 in place of the element 512b. The overall result 508 of this iteration of the folding phase 404 may serve as an input to a next iteration of the folding phase 404,

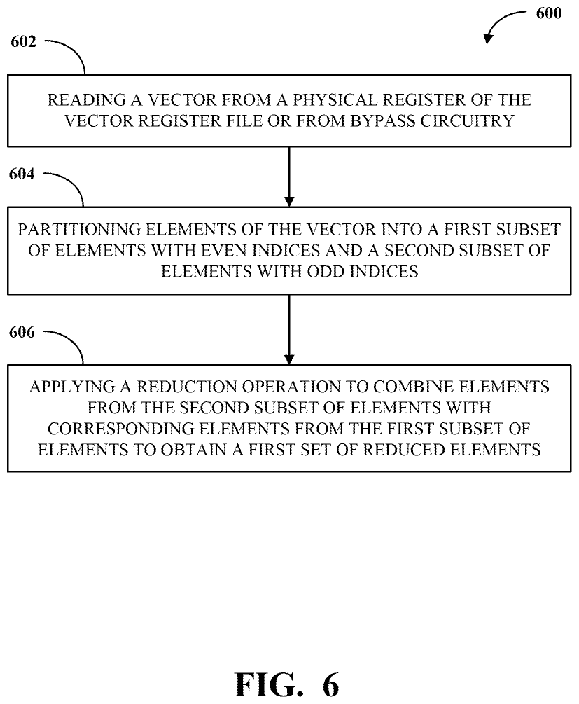

FIG. 6 is a flowchart of an example of a technique 600 for accelerated vector-reduction operations that may be implemented by execution circuitry, such as the execution circuitry 340, communicatively coupled to a vector register file, such as the vector register file 330.

The step 602 comprises reading a vector from a physical register of the vector register file or from bypass circuitry. The vector may be the elements 430 of FIG. 4; the physical register may be the temporary register 417 of FIG. 4; and the vector register file may be the vector register file 330 of FIG. 3.

The step 604 comprises partitioning elements of the vector into a first subset of elements with even indices and a second subset of elements with odd indices. The elements of the vector may be the elements 504 (and in some cases also the elements 506) of FIG. 5. The first subset of elements may be the even segments 510a, 510b, 510c, and 510d of FIG. 5. The second subset of elements may be the odd segments 512a, 512b, 512c, and 512d of FIG. 5.

The step 606 comprises applying a reduction operation to combine elements from the second subset of elements with corresponding elements from the first subset of elements to obtain a first set of reduced elements. The reduction operation may be applied via the execution units 530a, 530b, and 530c of FIG. 5. The set of reduced elements may be the results 540a, 540b, and 540c (and in some cases also the result 540d) of FIG. 5. In some implementations, the execution circuitry is configured to, where the vector has an odd number of elements, apply the reduction operation to an unmatched member of the first subset of elements and an identity value 514 of the reduction operation. In some implementations, the reduction operation is one or integer addition or floating-point addition. In some implementations, the reduction operation is an operation from a set of operations that includes integer addition, integer minimum, integer maximum, floating-point addition, floating-point minimum, floating-point maximum, logical AND, logical OR, and logical XOR. In some implementations, the execution circuitry comprises one or more pipelined execution units.

In a first aspect, the subject matter described in this specification can be embodied in an integrated circuit that includes a vector register file configured to store register values of an instruction set architecture in physical registers; and an execution circuitry configured to, responsive to a folding micro-op: read a vector from a physical register of the vector register file or from bypass circuitry; partition elements of the vector into a first subset of elements with even indices and a second subset of elements with odd indices; and apply a reduction operation to combine elements from the second subset of elements with corresponding elements from the first subset of elements to obtain a first set of reduced elements.

In the first aspect, the execution circuitry may be configured to, where the vector has an odd number of elements, apply the reduction operation to an unmatched member of the first subset of elements and an identity value of the reduction operation.

In the first aspect, the reduction operation may be one of integer addition or floating-point addition.

In the first aspect, the reduction operation may be an operation from a set of operations that includes integer addition, integer minimum, integer maximum, floating-point addition, floating-point minimum, floating-point maximum, logical AND, logical OR, and logical XOR.

In the first aspect, the execution circuitry may include one or more pipelined execution units.

In the first aspect, the execution circuitry may be configured to, in an early phase of a reduction operation applied to a large vector with elements stored in multiple physical registers of the vector register file: read a third subset of the elements of the large vector from a first physical register of the vector register file or from bypass circuitry; read a fourth subset of the elements of the large vector from a second physical register of the vector register file or from bypass circuitry; and apply the reduction operation to combine elements from the fourth subset of elements with corresponding elements from the third subset of elements to obtain a second set of reduced elements.

In the first aspect, the execution circuitry may be configured to, where the large vector has an odd number of elements, apply the reduction operation to an unmatched member of the third subset of elements and an identity value of the reduction operation.

In the first aspect, the integrated circuit may include a second execution circuitry that is configured to, in an early phase of a reduction operation applied to a large vector with elements stored in multiple physical registers of the vector register file: read a third subset of the elements of the large vector from a first physical register of the vector register file or from bypass circuitry; read a fourth subset of the elements of the large vector from a second physical register of the vector register file or from bypass circuitry; and apply the reduction operation to combine elements from the fourth subset of elements with corresponding elements from the third subset of elements obtain a second set of reduced elements.

In the first aspect, the second execution circuitry may be configured to, where the large vector has an odd number of elements, apply the reduction operation to an unmatched member of the third subset of elements and an identity value of the reduction operation.

In the first aspect, the second execution circuitry may include one or more pipelined execution units.

In a second aspect, the subject matter described in this specification can be embodied in a non-transitory computer-readable medium comprising a circuit representation that, when processed by a computer, is used to program or manufacture an integrated circuit that includes: a vector register file configured to store register values of an instruction set architecture in physical registers; and an execution circuitry configured to, responsive to a folding micro-op: read a vector from a physical register of the vector register file or from bypass circuitry; partition elements of the vector into a first subset of elements with even indices and a second subset of elements with odd indices; and apply a reduction operation to combine elements from the second subset of elements with corresponding elements from the first subset of elements to obtain a first set of reduced elements.

In the second aspect, the execution circuitry may be configured to, where the vector has an odd number of elements, apply the reduction operation to an unmatched member of the first subset of elements and an identity value of the reduction operation.

In the second aspect, the reduction operation may be one or integer addition or floating-point addition.

In the second aspect, the reduction operation may be an operation from a set of operations that includes integer addition, integer minimum, integer maximum, floating-point addition, floating-point minimum, floating-point maximum, logical AND, logical OR, and logical XOR.

In the second aspect, the execution circuitry may include one or more pipelined execution units.

In the second aspect, the execution circuitry may be configured to, in an early phase of the macro-operation applied to a large vector with elements stored in multiple physical registers of the vector register file: read a third subset of the elements of the large vector from a first physical register of the vector register file or from bypass circuitry; read a fourth subset of the elements of the large vector from a second physical register of the vector register file or from bypass circuitry; and apply the reduction operation to combine elements from the fourth subset of elements with corresponding elements from the third subset of elements to obtain a second set of reduced elements.

In the second aspect, the execution circuitry may be configured to, where the large vector has an odd number of elements, apply the reduction operation to an unmatched member of the third subset of elements and an identity value of the reduction operation.

In the second aspect, the integrated circuit may include a second execution circuitry that is configured to, in an early phase of the macro-operation applied to a large vector with elements stored in multiple physical registers of the vector register file: read a third subset of the elements of the large vector from a first physical register of the vector register file or from bypass circuitry; read a fourth subset of the elements of the large vector from a second physical register of the vector register file or from bypass circuitry; and apply the reduction operation to combine elements from the fourth subset of elements with corresponding elements from the third subset of elements obtain a second set of reduced elements.

In a third aspect, the subject matter described in this specification can be embodied in a method that includes: reading a vector from a physical register of a vector register file or from bypass circuitry; partitioning elements of the vector into a first subset of elements with even indices and a second subset of elements with odd indices; and applying a reduction operation to combine elements from the second subset of elements with corresponding elements from the first subset of elements to obtain a first set of reduced elements.

In the third aspect, the method may include: determining whether the vector has an odd number of elements; and in response to the vector having an odd number of elements, applying the reduction operation to an unmatched member of the first subset of elements and an identity value of the reduction operation.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An integrated circuit comprising:
a vector register file configured to store register values of an instruction set architecture in physical registers; and
an execution circuitry configured to, responsive to a folding micro-op:
read a vector from a physical register of the vector register file or from bypass circuitry;
partition elements of the vector into a first subset of elements with even indices and a second subset of elements with odd indices; and
apply a reduction operation to combine elements from the second subset of elements with corresponding elements from the first subset of elements to obtain a first set of reduced elements.

2. The integrated circuit of claim 1, wherein the execution circuitry is configured to, where the vector has an odd number of elements, apply the reduction operation to an unmatched member of the first subset of elements and an identity value of the reduction operation.

3. The integrated circuit of claim 1, wherein the reduction operation is one of integer addition or floating-point addition.

4. The integrated circuit of claim 1, wherein the reduction operation is an operation from a set of operations that includes integer addition, integer minimum, integer maximum, floating-point addition, floating-point minimum, floating-point maximum, logical AND, logical OR, and logical XOR.

5. The integrated circuit of claim 1, wherein the execution circuitry comprises one or more pipelined execution units.

6. The integrated circuit of claim 1, wherein the execution circuitry is configured to, in an early phase of a reduction operation applied to a large vector with elements stored in multiple physical registers of the vector register file:
read a third subset of the elements of the large vector from a first physical register of the vector register file or from bypass circuitry;
read a fourth subset of the elements of the large vector from a second physical register of the vector register file or from bypass circuitry; and
apply the reduction operation to combine elements from the fourth subset of elements with corresponding elements from the third subset of elements to obtain a second set of reduced elements.

7. The integrated circuit of claim 6, wherein the execution circuitry is configured to, where the large vector has an odd number of elements, apply the reduction operation to an unmatched member of the third subset of elements and an identity value of the reduction operation.

8. The integrated circuit of claim 1, comprising a second execution circuitry that is configured to, in an early phase of a reduction operation applied to a large vector with elements stored in multiple physical registers of the vector register file:
read a third subset of the elements of the large vector from a first physical register of the vector register file or from bypass circuitry;
read a fourth subset of the elements of the large vector from a second physical register of the vector register file or from bypass circuitry; and
apply the reduction operation to combine elements from the fourth subset of elements with corresponding elements from the third subset of elements obtain a second set of reduced elements.

9. The integrated circuit of claim 8, wherein the second execution circuitry is configured to, where the large vector has an odd number of elements, apply the reduction operation to an unmatched member of the third subset of elements and an identity value of the reduction operation.

10. The integrated circuit of claim 8, wherein the second execution circuitry comprises one or more pipelined execution units.

11. A non-transitory computer-readable medium comprising a circuit representation that, when processed by a computer, is used to program or manufacture an integrated circuit comprising:
a vector register file configured to store register values of an instruction set architecture in physical registers; and
an execution circuitry configured to, responsive to a folding micro-op:
read a vector from a physical register of the vector register file or from bypass circuitry;
partition elements of the vector into a first subset of elements with even indices and a second subset of elements with odd indices; and
apply a reduction operation to combine elements from the second subset of elements with corresponding elements from the first subset of elements to obtain a first set of reduced elements.

12. The non-transitory computer-readable medium of claim 11, wherein the execution circuitry is configured to, where the vector has an odd number of elements, apply the reduction operation to an unmatched member of the first subset of elements and an identity value of the reduction operation.

13. The non-transitory computer-readable medium of claim 11, wherein the reduction operation is one of integer addition or floating-point addition.

14. The non-transitory computer-readable medium of claim 11, wherein the reduction operation is an operation from a set of operations that includes integer addition, integer minimum, integer maximum, floating-point addition, floating-point minimum, floating-point maximum, logical AND, logical OR, and logical XOR.

15. The non-transitory computer-readable medium of claim 11, wherein the execution circuitry comprises one or more pipelined execution units.

16. The non-transitory computer-readable medium of claim 11, wherein the execution circuitry is configured to, in an early phase of a reduction operation applied to a large vector with elements stored in multiple physical registers of the vector register file:
read a third subset of the elements of the large vector from a first physical register of the vector register file or from bypass circuitry;
read a fourth subset of the elements of the large vector from a second physical register of the vector register file or from bypass circuitry; and
apply the reduction operation to combine elements from the fourth subset of elements with corresponding elements from the third subset of elements to obtain a second set of reduced elements.

17. The non-transitory computer-readable medium of claim 16, wherein the execution circuitry is configured to, where the large vector has an odd number of elements, apply the reduction operation to an unmatched member of the third subset of elements and an identity value of the reduction operation.

18. The non-transitory computer-readable medium of claim 11, comprising a second execution circuitry that is configured to, in an early phase of a reduction operation applied to a large vector with elements stored in multiple physical registers of the vector register file:
read a third subset of the elements of the large vector from a first physical register of the vector register file or from bypass circuitry;
read a fourth subset of the elements of the large vector from a second physical register of the vector register file or from bypass circuitry; and
apply the reduction operation to combine elements from the fourth subset of elements with corresponding elements from the third subset of elements obtain a second set of reduced elements.

19. A method, comprising:
reading a vector from a physical register of a vector register file or from bypass circuitry;
partitioning elements of the vector into a first subset of elements with even indices and a second subset of elements with odd indices; and
applying a reduction operation to combine elements from the second subset of elements with corresponding elements from the first subset of elements to obtain a first set of reduced elements.

20. The method of claim 19, further comprising,
determining whether the vector has an odd number of elements; and
in response to the vector having an odd number of elements, applying the reduction operation to an unmatched member of the first subset of elements and an identity value of the reduction operation.
